(19) United States
(12) Patent Application Publication
(10) Pub. No.: US 2011/0030060 A1
(43) Pub. Date: Feb. 3, 2011

(54) METHOD FOR DETECTING MALICIOUS JAVASCRIPT

(75) Inventor: NIDHI GOVINDRAM KEJRIWAL, Atlanta, GA (US)

Correspondence Address: PATENTRY, P.O. BOX 151616, SAN RAFAEL, CA, 94915-1616, US

(73) Assignee: BARRACUDA NETWORKS, INC., CAMPBELL, CA (US)

(21) Appl. No.: 12/849,721

(22) Filed: Aug. 3, 2010

Related U.S. Application Data
(60) Provisional application No. 61/273,334, filed on Aug. 3, 2009.

(51) Int. Cl. G06F 21/00

(52) U.S. Cl. 726/25

(57) ABSTRACT

A method provides Dynamic Analysis to identify URL provisioning malicious javascripts comprising tracing frequently used javascript feature used to either inject malicious javascript in html response or redirecting user to the website that is serving malicious contents. An apparatus embodiment operates in the cloud in the middle where it identifies javascript in the response traffic and then requests the other corresponding javascript and can make a determination before delivering the original content to the user.

A related application is provisional application 61/273334 filed Aug. 3, 2009 Web Security Systems and Methods which is incorporated in its entirety by reference.

### BACKGROUND

Most malicious web-based activity involves malicious javascript. Detecting and blocking malicious javascript is essential for preventing web-based compromises. Most malicious javascript is obfuscated, which renders static analysis, such as signature matching, approaches ineffective.

Legitimate javascript is also obfuscated so simply identifying obfuscation is insufficient. Too many false negative false positive fails. What is needed is a system to detect and prevent browser based malicious javascript contents.

### BRIEF DESCRIPTION OF DRAWINGS

FIG. 1 is a dataflow diagram of a system.

### SUMMARY OF THE INVENTION

A system that can detect and prevent browser based malicious javascript contents. MJD (Malicious Javascript Detection) is a pluggable module that achieves this by emulating html response in sandboxed browser environment that traces sensitive data access and dangerous function usage. MJD concentrates on detecting malicious javascript embedded in html response itself. The method comprises emulating html response in sandboxed browser environment that traces sensitive data access and dangerous function usage by detecting malicious javascript embedded in html response itself. The process includes
1. Place content into a virtual browser environment,
2. Perform behavioral analysis of javascript to determine its intentions e.g. cookie theft alert when cookie from one site sent to another e.g. examine actions of new javascript when written to a page.
   how many createElement calls,
   check for presence of unicode-encoded shell code.

A method provides Dynamic Analysis comprising

tracing frequently used javascript feature used to either inject malicious javascript in html response or redirecting user to the website that is serving malicious contents.

The method of Dynamic Analysis further comprises the steps emulating the response received for client request in a sandboxed environment where use of sensitive javascript functions is traced and argument to those function are analyzed for malicious contents. Tracing is achieved by hooking and changing the implementation of those functions.

### DETAILED DISCLOSURE OF EMBODIMENTS

Dynamic Analysis: Dynamically trace frequently used javascript feature used to either inject malicious javascript in html response or redirecting user to the website that is serving malicious contents. Advantage of this approach is relatively shorter period of prototyping and reasonable performance.

Dynamic Analysis: Dynamic analysis is done by emulating the response received for client request in a sandboxed environment where use of sensitive javascript functions is traced and argument to those function are analyzed for malicious contents. Tracing is achieved by hooking and changing the implementation of those functions.

Sandboxed environment: This is a browser emulation environment created using Rhino and HtmlUnit.
Rhino
   Mozilla open source javascript engine
   Version: 1.7R1
   Provides important javascript engine component to the project under MPL1.1/GPL 2.0 license
   Written in Java
HtmlUnit
   Gargoyle Software open source GUI-Less browser
   Version: 2.4
   Provides important DOM (Document Object Model) of the browser pre integrated with Rhino. Available under Apache2.0 license.
   Written in Java

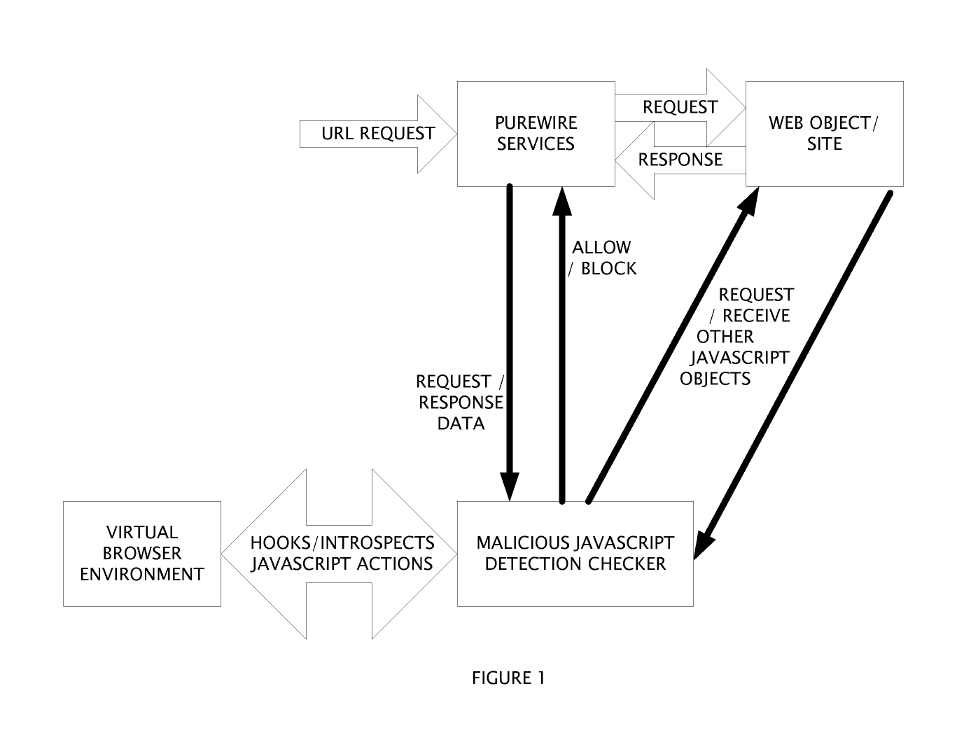

The overall conceptual design for the system is shown in FIG. 1.

1. A User Http request is received at a service

2. MN) examines and forwards the request to website

3. Receiving a Response from a website

3a. Embedded javascript if any transferred to Virtual Browser Environment

3b. Embedded javascript response traced by hooks on javascript actions

4. Analyzing response for malicious/suspicious behaviors

5. Enabling or blocking message to User from PWSS depending on result in (4)

Input expected: Html Response body.

Output intended: Categorization vulnerabilities found in response if any to at least one of the following categories:
1. createElement Original url, script source
2. iframe_suspicious Original url, destination url, script source
3. iframe_block Orignal url, desitnation url, script source
4. cookie (via htmltag) Orignal url, destination url, script source
5. malware keywordsOriginal url, script source (**look at the logs for actual contents)
6. location url Original url, destination url, script source
7. cookie theft (via addition operation tracing) Original url, script source
8. document.write via img/script tag Original url, destination url, script source

There are two modules:
Response Module
Request Module

### Response Module

In an embodiment the response module receives a user request from a Purewire Service (pwss). Response module makes a request to the cloud and emulates the response if it is html. Response module only requests the embedding javascripts from the html page. Any other request such as for images or iframed src request are not requested because they may not contribute to the javascript execution of the page and performance impact on the response time could be significant. Also all these contents would need to be cached to keep system from any state related issues.

Patterns caught by response module:
a) Heap Spray (Category 1): This technique of attack tries to write a predetermined portion of the heap with executable code. This could be achieved by allocating large blocks on memory on heap and then writing the blocks with right values. The execution of memory is achieved by taking advantage of some vulnerability which would point execution pointer to the vulnerable code on heap.
   1. One such way exploited in MS09-002 which creates large number of objects. This could be simply caught by counting number of CreateElement in a given script and flag if the count is above threshold.
   2. Second pattern (TODO): Large memory write with unicode characters
b) Decoded/Deobfuscated contents: fromCharCode( ), unescape( ) functions are traced that are highly used by attackers today to decode contents at some point.
c) Document.write (Category 2,3 & 8): Check the contents javascript about to dynamically write on the page. Hurisitics/pattern applied:
   1. iframe ‘src’ should be pointing the domain other than origin (host) domain. This is rather common, such as in case “widget” like bookmarking appended on the page which are appended dynamically via javascript to iframe. Hence this is flagged categorized as (2). We overcome this by tracing if the iframe contents have been decoded before which is a pretty good indicator of malicious contents hence categorized as (3). However sometimes these write could be via <script> tag or <img> tag both of which load and pointed contents on page load event itself. Hence these are flagged as (8).
d) eval: check eval which is javascript evaluation function and executes javascript code passed as a string argument. These contents could be checked for presence of the malicious keywords, or large unicode strings for shellcode, vulnerable clsid etc. In addition if these contents are decoded before as in (b), that gives a pretty good indication of the malicious contents. These are flagged as category (5).
e) Cookie theft:
   1. Maintain a cookie jar with set-cookie header value.
   2.Document.cookie: Trace the value returned from document.getCookie( )function. There is no legitimate reason of appending a cookie to the url. The site that owns the cookie would receive that cookie as ‘cookie’ request header when the request is made to that domain. So if that same value (getCookie( )) is appended to a url (or rather strings that fits url pattern) and the url is not same domain as the origin domain of the cookie, then we can raise the cookie theft flag for that url. Flagged as category (4) and (8). There is duplication here and that is because if the cookie is appended to the url but the resulting url is not written to the page using document.write operation we could miss this operation. Research will find the way to remove this duplication.
   3. (TODO) If possible trace the cookie value manipulation and store modified cookie value in the cookiejar as well to identify the cookie theft in event

### Request Module

a) Check incoming request is the domain is matches url categorized by response module. Generate block message/category if it does.
b) Check url if it contains the string that matches values in cookie jar. If it does and domain is not same as the cookie domain, that could lead to cookie theft.

In an embodiment, creating a browser emulation environment comprising Rhino and HtmlUnit, known in the art.

The steps include

receiving a user http request,

examining and forwarding the request to cloud,

receiving an embedded javascript response from the cloud

receiving an embedded javascript request if any from the cloud

forwarding the analyzed response if no malicious javascript

and blocking message to the user if malicious javascript found.

The method categorizes vulnerabilities into at least one of the following
1 create element
2 suspicious iframe
3 block iframe
4 cookie
5 malware keywords
6 location url
7 cookie theft
8 document write via img/script tag

The method further comprising operating a response module passing user request to the response module requesting to the cloud and emulates the response if it is html requesting the embedding javascripts from the html page no requests for images or iframed src request.

Methods include catching patterns by
detecting writing to a predetermined portion of the heap with executable code.
detecting attempt to point execution pointer to the vulnerable code on heap.
detecting creation of large number of objects by counting number of createElement in a given script and compare with a threshold.
detecting large memory write with unicode characters
detecting fromCharCode( )and unescape( ) functions
detecting dynamically document write on the page.
checking the contents javascript about to dynamically write on the page and tracing if the iframe contents have been decoded before. if script tag or img tag, flag as document write.
checking contents of eval function which executes javascript code passed as a string argument for presence of the malicious keywords or large unicode strings for shellcode, vulnerable clsid etc.
   An other method comprises
   maintaining a cookie jar with set-cookie header value and tracing the value returned from document.getCookie( ) function.

The method further comprises tracing the cookie value manipulation and store modified cookie in the cookiejar as well to identify the cookie theft in event.

The method further comprises, in a request module,
checking incoming request and blocking if the domain matches url categorized in response module; and
checking url if it contains the string that matches values in cookie jar, and domain is not same as the cookie domain, categorize as cookie theft.

A method embodiment for dynamically tracing frequently used javascript features to detect a uniform resource identifier provisioning a malicious javascript content in response to http requests comprises:

receiving a read request to a uniform resource locator (URL);

initializing a browser;

reading the requested URL;

loading a page comprising html and embedded javascript;

executing the javascript;

tracing execution of at least one frequently used javascript feature used to either redirect users to a website serving malicious contents or used to inject malicious javascript in html response, and

categorizing vulnerabilities and storing the URL when malicious contents are found.

In an embodiment, the frequently used javascript feature comprises one or more of fromCharCode( ) and unescape( ) whereby contents are decoded.

In an embodiment, the frequently used javascript feature comprises eval and its string argument comprises malicious keywords.

In an embodiment, the frequently used javascript feature comprises eval and its string argument comprises large unicode strings.

In an embodiment, the string argument of javascript feature eval is the decoded content and the method further comprises storing a vulnerability category 5.

In an embodiment, the frequently used javascript feature comprises CreateElement and the method further comprises counting the number of CreateElement instances in the javascript and comparing the number with a threshold, the method further comprises storing a vulnerability category 1.

In an embodiment, the frequently used javascript feature is document.write.

In an embodiment, the method further comprises finding a <script> tag and further comprises storing a vulnerability category 8.

In an embodiment, the method further comprises finding an <image> tag and further comprises storing a vulnerability category 8.

In an embodiment, the method further comprises finding an iframe ‘src“.

In an embodiment the method further comprises finding fromCharcode( ) and unescape( ) whereby the iframe contents have been decoded before document.write and the method further comprises storing a vulnerability category 3.

In an embodiment, the frequently used javascript feature comprises large memory write with unicode characters and the method further comprises storing a vulnerability category 1.

An other method embodiment comprises
maintaining a cookie jar with set-cookie header value;
tracing a value returned from document.getCookie( );
storing the URL as cookie theft content when the url is not same
domain as the origin domain of the cookie and
further comprising storing a vulnerability category 4 and 8.

In an embodiment the method further comprises tracing the cookie value manipulation and storing the modified cookie into the cookie jar to identify the cookie theft event.

### Conclusion

The invention can be easily distinguished from conventional methods and systems by an apparatus embodiment which operates in the cloud in the middle where it identifies javascript in the response traffic and then requests the other corresponding javascript and can make a determination before delivering the original content to the user.

What is claimed is:

1. A method for dynamically tracing frequently used javascript features to detect a uniform resource identifier provisioning a malicious javascript content in response to http requests comprising:
receiving a read request to a uniform resource locator (URL);
initializing a browser;
reading the requested URL;
loading a page comprising html and embedded javascript;
executing the javascript;
tracing execution of at least one frequently used javascript feature used to either redirect users to a website serving malicious contents or used to inject malicious javascript in html response, and
categorizing vulnerabilities and storing the URL when malicious contents are found.

2. The method of claim 1 wherein the frequently used javascript feature comprises one or more of fromCharCodeO and unescape( ) whereby contents are decoded.

3. The method of claim 1 wherein the frequently used javascript feature comprises eval and its string argument comprises malicious keywords.

4. The method of claim 1 wherein the frequently used javascript feature comprises eval and its string argument comprises large unicode strings.

5. The method of claim 2 wherein the string argument of javascript feature eval is the decoded content and further comprising storing a vulnerability category 5.

6. The method of claim 1 wherein the frequently used javascript feature comprises CreateElement and the method further comprises counting the number of CreateElement instances in the javascript and comparing the number with a threshold further comprising storing a vulnerability category 1.

7. The method of claim 1 wherein the frequently used javascript feature is document.write.

8. The method of claim 7 further comprising a <script>tag further comprising storing a vulnerability category 8.

9. The method of claim 7 further comprising an <image>tag further comprising storing a vulnerability category 8.

10. The method of claim 7 further comprising an iframe ‘src”.

11. The method of claim 10 further comprising fromCharcode( ) and unescape( ) whereby the iframe contents have been decoded before document.write and further comprising storing a vulnerability category 3.

12. The method of claim 1 wherein the frequently used javascript feature comprises large memory write with unicode characters further comprising storing a vulnerability category 1.

13. A method comprising
maintaining a cookie jar with set-cookie header value;
tracing a value returned from document.getCookie( )
storing the URL as cookie theft content when the url is not same
domain as the origin domain of the cookie and
further comprising storing a vulnerability category 4 and 8.

14. The method of claim 14 further comprising tracing the cookie value manipulation and storing the modified cookie into the cookie jar to identify the cookie theft event.

15. An apparatus embodiment which operates in the cloud in the middle comprising
means for identifying javascript in response traffic,
means for requesting corresponding javascript and
means for determining that requested javascript is not malicious before delivering content to a user.
